(19) United States
(12) Patent Application Publication
(10) Pub. No.: US 2009/0102264 A1
(43) Pub. Date: Apr. 23, 2009

(54) Vehicle Seat

(75) Inventors: Karl-Heinz Fischer, Esslingen (DE); Guenter Hoelzel, Hochdorf (DE); Helge Schmidt-Spalding, Neumuenster (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/795,203

(22) PCT Filed: Dec. 13, 2005
(86) PCT No.: PCT/EP05/13351

§ 371 Date: May 9, 2008

(30) Foreign Application Priority Data
Jan. 15, 2005 (DE) 10 2005 001 960.9

(51) Int. Cl. B60N 2/00

(52) U.S. Cl. 297/354.1

(57) ABSTRACT

A vehicle seat has a backrest with a backrest frame, attached to a seat supporting structure, that can be pivoted to a limited extent about a horizontal axis of rotation in order to permit active sitting. To permit active sitting even at high transverse acceleration forces, as occur during the operation of a motor vehicle, two bearing devices are attached to the backrest frame, and a backrest basic body is mounted on the bearing devices so that it can rotate about the horizontal axis of rotation.

### BACKGROUND AND SUMMARY OF THE INVENTION

This invention relates to a vehicle seat with a backrest that has a backrest frame attached to a seat supporting structure and pivotable to a limited extent about a horizontal axis of rotation in order to permit active sitting.

During active sitting, the lower part of the backrest is pivoted forward, as a result of which the pelvis of a person sitting on the vehicle seat is straightened up, and vice versa. German utility model document DE 90 06 316 U1 discloses a seat with two back shells which are arranged laterally and are fastened to a common transverse rail via a respective leaf spring with a coil. European patent EP 0 107 627 B1 discloses a chair with a seat and a backrest. The backrest is able to move from a straightened-up position relative to the seat into a partially tilted position. The known chair is inter alia characterized in that the backrest is formed from a row of at least three segments which are arranged one above another, are connected to one another in an articulated manner about corresponding, horizontal axes and are arranged in such a manner that, in the partially tilted position of the backrest, they form a curve with a curvature which essentially corresponds to the curvature of the curved back of a user. European patent EP 0 537 839 B1 discloses a supporting element for seats, which comprises two panel-like side bodies and a generally flexible, connecting intermediate body which extends in the manner of a bridge between the inner ends of the side bodies. The above-described seat structures are not readily suitable for use in motor vehicles. German patent DE 37 07 926 C2 discloses a vehicle seat with a backrest which, as a supporting structural element, has a molded shell with a central part and side guide parts which are integral therewith and extend away laterally forward. The molded shell is matched approximately to the back width of an average to large seat user. The side guide parts are designed such that they can be pivoted resiliently in relation to the central part and are suspended in such a manner on an essentially flexurally rigid backrest frame that, in the case of individuals who are narrower than the structurally predetermined width of the molded shell, the side guide parts move toward each other shifting the central part back. German patent DE 39 10 143 C2 discloses a motor vehicle seat with a backrest and a pair of side supports which are connected pivotably to both sides of the backrest via corresponding pivoting shafts.

It is the object of the invention to provide a vehicle seat with a backrest which has a backrest frame which is attached to a seat supporting structure and can be pivoted to a limited extent about a horizontal axis of rotation in order to permit active sitting, which vehicle seat permits active sitting even in the case of high transverse acceleration forces, as occur during the operation of a motor vehicle.

This object is achieved in the case of a vehicle seat with a backrest which has a backrest frame which is attached to a seat supporting structure and can be pivoted to a limited extent about a horizontal axis of rotation in order to permit active sitting. Two bearing devices are attached to the backrest frame, and a backrest basic body is mounted on the bearing devices in a manner such that it can rotate about the horizontal axis of rotation. The backrest is preferably coupled at its end facing the seat surface to the seat support structure. This makes it possible to adjust the inclination or to fold the backrest over. During operation, the backrest is fixed with respect to the coupling at the end facing the seat surface. In order to permit active sitting, the backrest can be rotated freely about the horizontal axis of rotation, which is preferably arranged level with the upper edge support of the pelvis, or can be rotated about a limited angle of rotation counter to the prestressing force of at least one spring device. This permits a frequent change of the loading of the intervertebral disks. The mounting of the backrest basic body in the backrest frame permits a stable mounting of the backrest basic body, which permits active sitting even in the case of high transverse acceleration forces, as occur during the operation of a motor vehicle.

In a preferred exemplary embodiment of the vehicle seat, the two bearing devices are guided displaceably in the longitudinal direction of the backrest on a respective guide rail attached to the backrest frame. This permits a height adjustment of the horizontal axis of rotation in a simple manner.

In a further preferred exemplary embodiment of the vehicle seat, the two bearing devices two further bearing devices for the backrest basic body are attached to the backrest frame and each have a rotation limiting element which is guided in an elongated hole. As a result, the angle of rotation of the backrest basic body relative to the backrest frame about the horizontal axis of rotation is limited. The backrest basic body is preferably prestressed into a central position by at least one spring device.

In a further preferred exemplary embodiment of the vehicle seat, the backrest is divided in the longitudinal direction and has two backrest shells which are attached to a plurality of retaining arms which run essentially horizontally. The two backrest shells permit a uniform enclosure of the upper body and the waist of an individual sitting on the vehicle seat.

In a further preferred exemplary embodiment of the vehicle seat, the retaining arms comprise a lower, an upper and a central pair of retaining arms, said central pair of retaining arms being arranged between the lower and the upper pair of retaining arms, as viewed in the longitudinal direction of the backrest. The three pairs of retaining arms permit an individual adjustment of the backrest shells without adversely affecting the stability of the mounting.

In a further preferred exemplary embodiment of the vehicle seat, on the retaining arms of the lower and of the upper pair of retaining arms, a respective supporting arm is guided displaceably in the longitudinal direction of the retaining arms. This permits a displacement of the bearing shells transversely with respect to one another.

In a further preferred exemplary embodiment of the vehicle seat, a respective fastening element is coupled to the ends of the supporting arms of the lower and of the upper pair of retaining arms. The coupling points of the fastening elements define essentially vertically running axes of rotation about which the bearing shells can be rotated for adjustment purposes. This permits an individual adjustment of the bearing shells.

In a further preferred exemplary embodiment of the vehicle seat, in the retaining arms of the central pair of retaining arms, a respective guide shoe, to which a lever arm is coupled, is guided displaceably in the longitudinal direction of the retaining arms. The guide shoes permit displacement of the bearing shells transversely with respect to one another.

In a further preferred exemplary embodiment of the vehicle seat, a respective fastening element is coupled to the ends of the lever arms. This permits a defined rotation of the bearing shells about the vertically running axes of rotation.

In a further preferred exemplary embodiment of the vehicle seat, the retaining arms of a pair of retaining arms are arranged at an obtuse angle with respect to one another. The pairs of retaining arms are preferably each connected fixedly to the backrest basic body.

Further advantages, features and details of the invention emerge from the description below, in which various exemplary embodiments are described in detail with reference to the drawing. The features mentioned in the claims and in the description may each be essential to the invention on their own or in any desired combination.

### BRIEF DESCRIPTION OF THE DRAWINGS

FIG. 1 shows a perspective illustration of a vehicle seat according to the invention from the side;

FIG. 2 shows the vehicle seat of FIG. 1 from the front;

FIG. 3 shows the vehicle seat of FIG. 1 obliquely from the front;

FIG. 4 shows a perspective illustration of the internal construction of a vehicle seat according to the invention obliquely from the front;

FIG. 5 shows the internal construction of FIG. 4 from the front; and

FIG. 6 shows the internal construction of FIGS. 4 and 5 obliquely from above.

### DETAILED DESCRIPTION OF THE INVENTION

In FIGS. 1 to 3, a vehicle seat 1 according to the invention is illustrated perspectively in various views. The vehicle seat 1 has a backrest 2 and a seat surface 3. The backrest 2 comprises a backrest frame 5 which is attached pivotably about an axis of rotation 7 to a seat supporting structure 9 to which the vehicle seat surface 3 is also attached. The backrest 2 is divided into two backrest shells 11, 12 which are attached to the backrest frame 5. In addition, a head restraint 13 is fastened to the backrest frame 5.

In FIG. 1, a double arrow 14 indicates that the backrest shells 11, 12 are displaceable in the longitudinal direction of the backrest frame 5. A displacement of the backrest shells 11, 12 in the direction of the double arrow 14 serves to match the backrests 2 to the shape of a vehicle occupant. It is furthermore indicated in FIG. 1 that the backrest shells 11, 12 can be pivoted to a limited extent about an axis of rotation 15, as indicated by a double arrow 16. Pivoting of the backrest shells 11, 12 about the axis of rotation 15 preferably takes place counter to the prestressing force of at least one spring device (not illustrated).

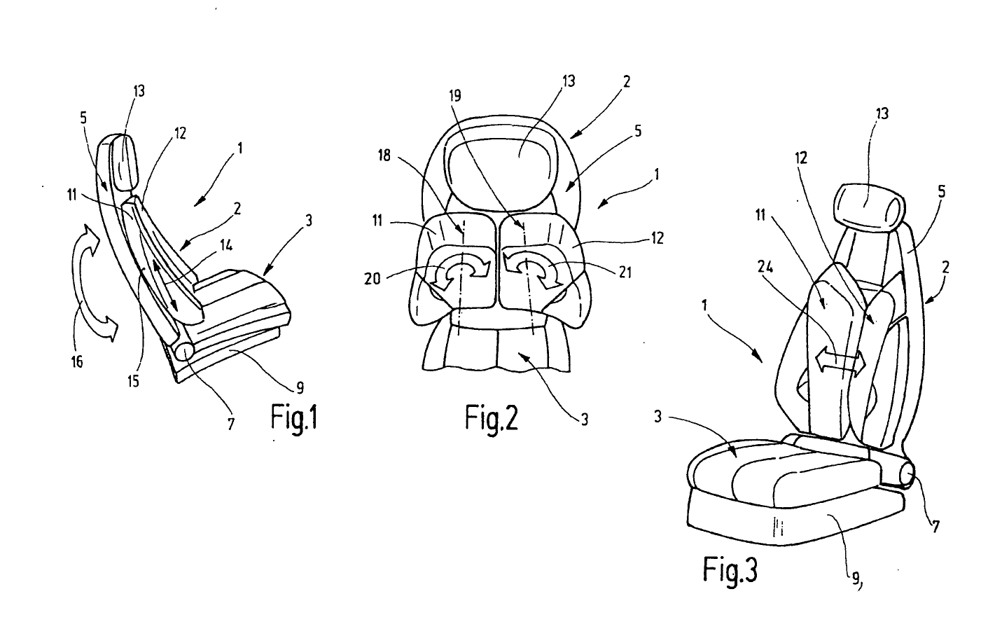

It is indicated in FIG. 2 that the backrest shells 11, 12 can furthermore be rotated about two axes of rotation 18, 19. The corresponding movement of the backrest shells 11, 12 about the axes of rotation 18, 19 is indicated by double arrows 21, 22.

In FIG. 3, it is indicated by a double arrow 24 that the two backrest shells 11, 12 are also attached to the backrest frame 5 in a manner such that they can be displaced transversely with respect to each other. The movement of the backrest shells 11, 12 in the direction of the double arrow 24 takes place, like the movement of the backrest shells 11, 12 in the direction of the double arrows 20, 21 (see FIG. 2), for adjustment purposes.

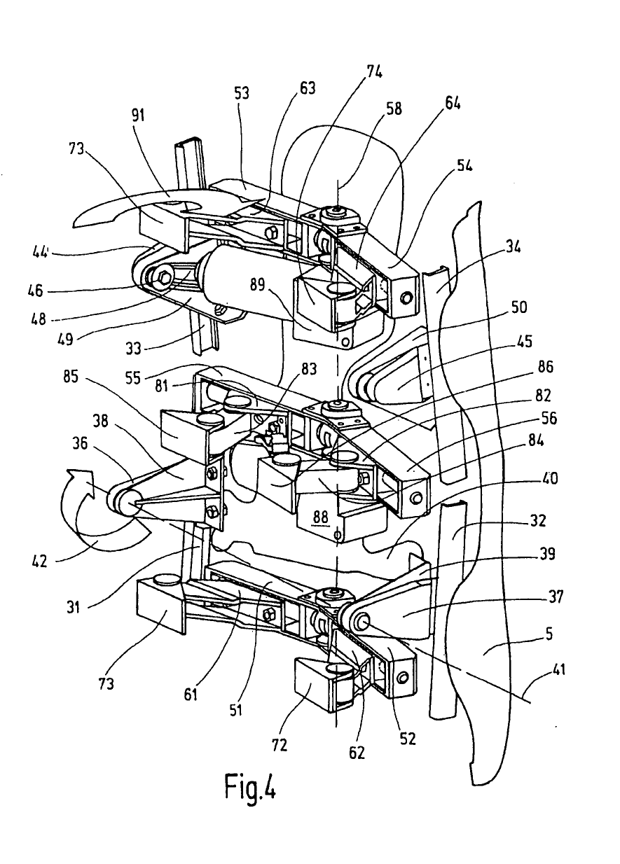

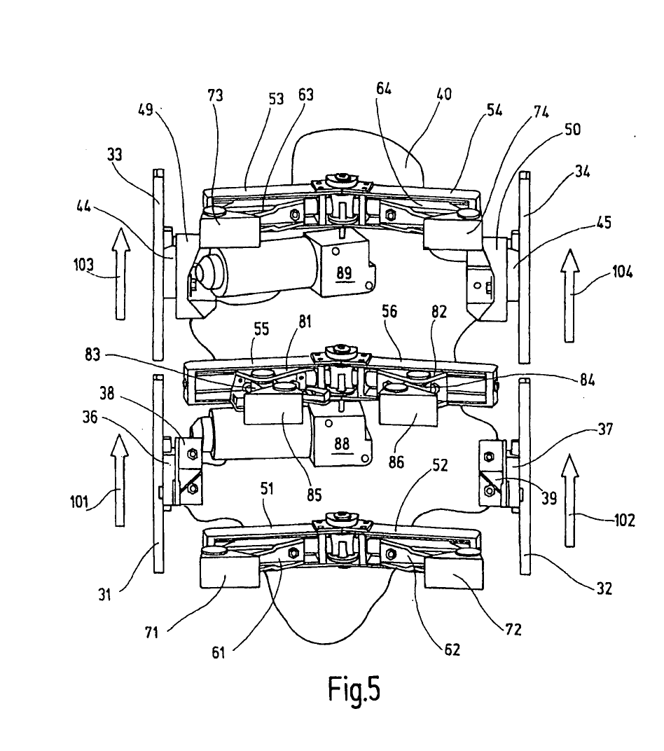

In FIGS. 4 to 6, the internal construction of the vehicle seat 1, which is illustrated in simplified form in FIGS. 1 to 3, is illustrated perspectively in various views. For clarity reasons, only part of the backrest frame 5 is illustrated schematically in FIG. 4. The backrest frame 5 may be of closed or open design, for example may be of U-shaped design. Four guide rails 31, 32, 33, 34 are fastened to the backrest frame 5. The guide rails 31 to 34 are arranged essentially in the longitudinal direction of the backrest. The two guide rails 31, 32 are arranged on two opposite sides in the lower half of the backrest and form a lower pair of guide rails. The two guide rails 33, 34 are arranged on two opposite sides in the upper half of the backrest and form an upper pair of guide rails.

A respective bearing bracket 36, 37 is guided in a manner such that it can be displaced in the longitudinal direction on the guide rails 31, 32. A bearing bracket 36, 37 together with a bearing support 38, 39 in each case forms a bearing device for a backrest basic body. The bearing supports 38, 39 are fastened to the backrest basic body 40. The fastening takes place preferably releasably, for example by means of screw connections. The bearing devices formed in each case by a bearing bracket 36, 37 and a bearing support 38, 39 permit the backrest basic body 40 to rotate about an axis of rotation 41. A rotational movement of the backrest basic body 40 about the axis of rotation 41 is indicated by an arrow 42. Of course, the rotation of the backrest basic body 40 can take place in both directions of rotation about the axis of rotation 41.

A respective bearing bracket 44, 45 is guided displaceably in the longitudinal direction on the guide rails 33, 34. A respective guide element protrudes inward from the free end of the bearing brackets 44, 45. In the case of the bearing bracket 44, it can be seen that the guide element is formed by a screw bolt 46 which is fastened by one end to the bearing bracket 44. The screw bolt 46 may be screwed, for example, into a correspondingly designed threaded hole in the bearing bracket 44. A screw head is provided at the other end of the screw bolt 46. The screw bolt 46 extends through an elongated hole 48 which is left free in a bearing support 49. The bearing support 49 and a bearing support 50, which is designed analogously in a mirror-inverted manner, are fastened to the backrest basic body 40. The angle of rotation during rotation of the backrest basic body 40 about the axis of rotation 41 is limited by the elongated holes in the bearing supports 49, 50.

In addition to the bearing supports 38, 39, 49, 50, six retaining arms 51 to 56 are fastened to the backrest basic body 40. The retaining arms 51 to 56 are arranged in pairs horizontally and at an obtuse angle of approximately 160 degrees with respect to one another. The retaining arms 51, 52 form a lower pair of retaining arms. The retaining arms 53, 54 form an upper pair of retaining arms. A central pair of retaining arms formed by the retaining arms 55, 56 is arranged between the pairs of retaining arms 51, 52 and 53, 54. The retaining arms 51 to 56 are arranged in such a manner that they butt in pairs against one another in the region of a center axis 58. They are fastened to the backrest basic body 40 in the region of the point of abutment.

In the retaining arms 51 to 54, a respective end of a supporting arm 61 to 64 is guided displaceably in the longitudinal direction of the retaining arms. A respective fastening element 71 to 74 is coupled to the free ends of the supporting arms 61 to 64. The fastening elements 71 to 74 serve to fasten bearing shells (not illustrated in FIG. 4).

In the retaining arms 55, 56, a respective guide shoe 81, 82 is guided displaceably in the longitudinal direction of the retaining arms. A respective end of a lever arm 83, 84 is coupled to the guide shoes 81, 82. A respective fastening element 85, 86 is coupled to the other end of the lever arms 83, 84.

The fastening elements 71, 73, 85 serve to fasten a first backrest shell. The fastening elements 72, 74, 86 serve to fasten a second backrest shell. Displacement of the guide shoes 81, 82 in the retaining arms 55, 56 makes it possible to rotate the backrest shells, as indicated on the left side in FIG. 4 by an arrow 91. A prerequisite for such a rotation of the backrest shells is that the supporting arms 61 to 64 retain their position relative to the assigned retaining arms 51 to 54.

In FIG. 5, it is indicated by arrows 101 to 104 that the backrest basic body 40 with the retaining arms 51 to 56 fastened thereto is displaceable vertically. Such a displacement, which, of course, can take place in both directions, can in particular adjust the height of the horizontal axis of rotation (41 in FIG. 4).

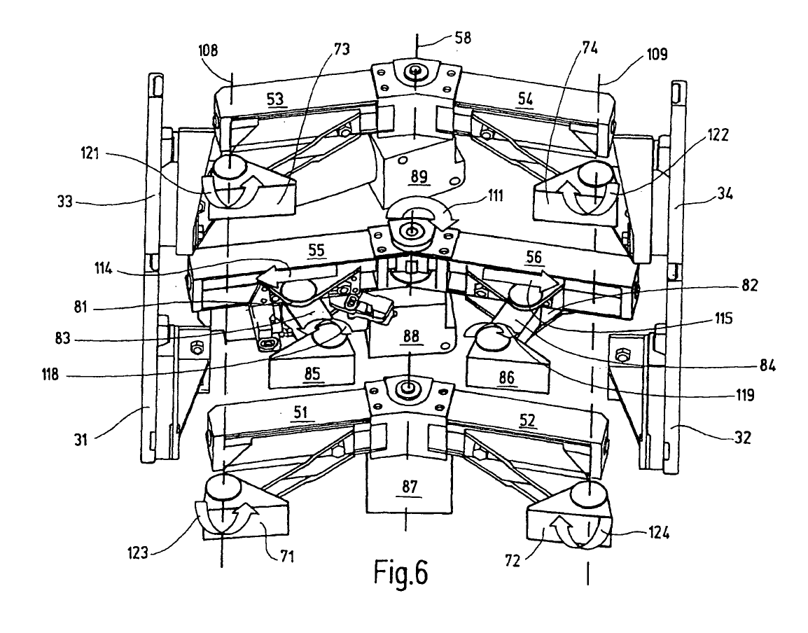

The pivoting of the backrest shells about vertical axes of rotation 108, 109 is explained below with reference to FIG. 6. A respective motor 87; 88; 89 with an associated gear device is arranged below the connecting points of the pairs of retaining arms 51, 52; 55, 56; 53, 54. A respective motor shaft which is assigned to a retaining arm can be rotated about the central axis 58 by the motors 87 to 89. The rotational movement of the motor shaft is transmitted with the aid of bevel gears and spindles to the supporting arms 61 to 64 or the guide shoes 81, 82.

For example, rotation of the motor shaft assigned to the motor 88 in the direction of an arrow 111 leads to the guide shoes 81, 82 being displaced outward in the retaining arms 55, 56, as indicated by arrows 114, 115. This movement in turn leads to the fastening elements 85, 86 with the backrest shells fastened thereto rotating in the direction of arrows 118, 119. These movements in turn lead to the fastening elements 71 to 74 rotating together with the backrest shells fastened thereto about the axes of rotation 108, 109, as indicated by arrows 121 to 124.

1-10. (canceled)

11. A vehicle seat with a backrest, which has a backrest frame that is attached to a seat supporting structure and that can be pivoted to a limited extent about a horizontal axis of rotation in order to permit active sitting, comprising:
two bearing devices attached to the backrest frame, and
a backrest basic body mounted on said bearing devices so that it can rotate about the horizontal axis of rotation.

12. The vehicle seat as claimed in claim 11, wherein the two bearing devices are guided displaceably in the longitudinal direction of the backrest on respective guide rails attached to the backrest frame.

13. The vehicle seat as claimed in claim 11, wherein, above the two bearing devices, two further bearing devices for the backrest basic body are attached to the backrest frame, and wherein each further bearing device has a rotation limiting element that is guided in an elongated hole.

14. The vehicle seat as claimed in claim 11, wherein the backrest is divided in the longitudinal direction and has two backrest shells attached to a plurality of retaining arms running essentially horizontally.

15. The vehicle seat as claimed in claim 14, wherein the retaining arms comprise lower, upper, and central pairs of retaining arms, and wherein said central pair of retaining arms is arranged between the lower and upper pairs of retaining arms as viewed in the longitudinal direction of the backrest.

16. The vehicle seat as claimed in claim 15, wherein, on the retaining arms of the lower and upper pairs of retaining arms, a respective supporting arm is guided displaceably in the longitudinal direction of the retaining arms.

17. The vehicle seat as claimed in claim 16, wherein a respective fastening element is coupled to the ends of the supporting arms of the lower and upper pairs of retaining arms.

18. The vehicle seat as claimed in claim 15, wherein on the retaining arms of the central pair of retaining arms, a respective guide shoe, to which a lever arm is coupled, is guided displaceably in the longitudinal direction of the retaining arms.

19. The vehicle seat as claimed in claim 18, wherein an end of each lever arm is coupled to a respective fastening element.

20. The vehicle seat as claimed in claim 15, wherein each retaining arm of a pair of retaining arms is arranged at an obtuse angle with respect to the other retaining arm of said pair.

21. The vehicle seat as claimed in claim 12, wherein, above the two bearing devices, two further bearing devices for the backrest basic body are attached to the backrest frame, and wherein each further bearing device has a rotation limiting element that is guided in an elongated hole.

22. The vehicle seat as claimed in claim 12, wherein the backrest is divided in the longitudinal direction and has two backrest shells attached to a plurality of retaining arms running essentially horizontally.

23. The vehicle seat as claimed in claim 13, wherein the backrest is divided in the longitudinal direction and has two backrest shells attached to a plurality of retaining arms running essentially horizontally.

24. The vehicle seat as claimed in claim 22, wherein the retaining arms comprise lower, upper, and central pairs of retaining arms, and wherein said central pair of retaining arms is arranged between the lower and upper pairs of retaining arms as viewed in the longitudinal direction of the backrest.

25. The vehicle seat as claimed in claim 23, wherein the retaining arms comprise lower, upper, and central pairs of retaining arms, and wherein said central pair of retaining arms is arranged between the lower and upper pairs of retaining arms as viewed in the longitudinal direction of the backrest.

26. The vehicle seat as claimed in claim 24, wherein, on the retaining arms of the lower and upper pairs of retaining arms, a respective supporting arm is guided displaceably in the longitudinal direction of the retaining arms.

27. The vehicle seat as claimed in claim 25, wherein, on the retaining arms of the lower and upper pairs of retaining arms, a respective supporting arm is guided displaceably in the longitudinal direction of the retaining arms.

28. The vehicle seat as claimed in claim 26, wherein a respective fastening element is coupled to the ends of the supporting arms of the lower and upper pairs of retaining arms.

29. The vehicle seat as claimed in claim 27, wherein a respective fastening element is coupled to the ends of the supporting arms of the lower and upper pairs of retaining arms.

30. The vehicle seat as claimed in claim 16, wherein on the retaining arms of the central pair of retaining arms, a respective guide shoe, to which a lever arm is coupled, is guided displaceably in the longitudinal direction of the retaining arms.
